(19) United States
(12) Patent Application Publication
(10) Pub. No.: US 2007/0193620 A1
(43) Pub. Date: Aug. 23, 2007

(54) Concentrating solar panel and related systems and methods

(76) Inventors: Braden E. Hines, Pasadena, CA (US); Richard L. Johnson JR., Suffolk, VA (US); Philip C. Irwin, Sierra Madre, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/654,256

(22) Filed: Jan. 17, 2007

Related U.S. Application Data
(60) Provisional application No. 60/759,778, filed on Jan. 17, 2006.

(51) Int. Cl. H02N 6/00

(52) U.S. Cl. 136/246

(57) ABSTRACT

The present invention relates to photovoltaic concentrating modules and related concentrating solar systems and methods. In particular, the present invention relates to concentrating modules, especially modules having a convenient size and market acceptance of traditional flat photovoltaic solar panels.

### PRIORITY CLAIM

The present nonprovisional patent Application claims priority under 35 U.S.C. §119(e) from U.S. Provisional Patent Application having Ser. No. 60/759,778, filed on Jan. 17, 2006, by Braden E. Hines and titled CONCENTRATING SOLAR PANEL AND RELATED SYSTEMS AND METHODS, wherein the entirety of said provisional patent application is incorporated herein by reference.

### FIELD OF THE INVENTION

The present invention relates to photovoltaic concentrating modules and related concentrating solar systems and methods. In particular, the present invention relates to concentrating modules and systems having a convenient size and market acceptance of traditional flat photovoltaic solar panels.

### BACKGROUND OF THE INVENTION

Traditional solar panels tend to be costly and typically take many years for the user's electric bill savings to pay back the cost of the panels. This has contributed to limiting the market penetration of photovoltaic solar power. It is desirable, therefore, to produce solar panels that either produce more power and/or that cost less.

Several advances have been made over the years with respect to solar power. For example, more efficient solar cells have been developed to produce more power per cell.

Another advance has been to concentrate sunlight so that more power can be obtained from smaller solar cells. Such photovoltaic solar concentrators have attempted to make use of this principle to varying degrees.

Photovoltaic solar concentrators have generally taken one of two approaches—either 1) build a large reflective trough or dish or a field of articulating mirrors which reflect light to a central point, where it is converted to power (such as by Solar Systems of Victoria, Australia; by Matlock et al., U.S. Pat. No. 4,000,734; by Gross et al., U.S. Pub. No. 2005/0034751), or 2) tightly pack a large number of small concentrators into a large panel such that the panel articulates rigidly to follow the sun (such as by Chen, U.S. Pub. No. 2003/0075212 or Stewart, U.S. Pub. No. 2005/0081908).

Another advance has appeared which is an attempt to combine the advantages of concentration with the convenience of the form factor of an ordinary solar panel (Fraas et al., U.S. Pub. No. 2003/0201007).

Another approach places rows of small concentrators onto a “lazy Susan” rotating ring-type arrangement (Cluff, U.S. Pat. No. 4,296,731). Another approach similar to Cluff's approach is presented by Lawheed in U.S. Pat. No. 6,498,290. Lawheed discloses an array of elongated concave parabolic trough-shaped reflectors such that sunlight is reflected and concentrated along a focal line of each elongated reflector. Winston (U.S. Pat. No. 4,003,638) discloses a trough that is a compound parabolic concentrator, producing a focus at its base.

Habraken et al. (U.S. Pub. No. 2004/0134531) disclose trough concentrators that include a lens at the mouth of the trough to help divert the incoming light prior to striking the reflective trough so as to help achieve a somewhat improved field of view and/or uniformity of illumination.

It is noted that Assignee's U.S. Provisional Patent Application No. 60/691,319, filed Jun. 16, 2005, in the names of Hines et al., titled PLANAR CONCENTRATING PHOTOVOLTAIC SOLAR PANEL WITH INDIVIDUALLY ARTICULATING CONCENTRATOR ELEMENTS, which application is incorporated herein by reference in its entirety for all purposes, describes a photovoltaic solar panel with individually articulating concentrator elements, which elements having the general form of a dish and articulating in two dimensions.

### SUMMARY OF THE INVENTION

The present invention includes numerous features in connection with solar concentrator modules and/or solar concentrator systems that can be helpful singly or in combination.

One feature of the present invention includes unique linear, photovoltaic concentrator modules that can be coupled with a support structure such that the module is moveable with respect to the support structure. Advantageously, such a module can be coupled with a support structure that is compatible with a pre-existing traditional solar panel form factor and/or can produce a similar amount of power to an equivalently-sized traditional solar panel.

Another feature of the present invention includes the unique linear, photovoltaic concentrator modules just mentioned where the modules have a unique hybrid reflective/refractive system.

Preferably, photovoltaic concentrator modules of the present invention are constructed to articulate in only one axis to point at and track the sun. Advantageously such an arrangement can help eliminate expensive large round bearing rings associated with a second axis.

Also, photovoltaic concentrator modules of the present invention preferably articulate individually with respect to a fixed support structure. Doing so can help maintain a low profile for a solar panel which can in turn help make the panel more suitable for rooftop installation.

Another feature of the present invention includes unique troughs of linear, photovoltaic concentrator modules. Advantageously, such troughs can function simultaneously as a concentrating optical element, a structural element, and a cooling element. As yet another advantage, such a trough can help eliminate, if desired, the need for separate components to perform these functions.

One or more additional advantages can result from the unique features mentioned above.

For example, a concentrator module according to the present invention can be compact in height thereby allowing modules to be packed together into a compact solar panel while still being able to articulate a module in concert with adjacent modules without collision among the articulating modules. Or, rather than packing the individual concentrators right next to each other, an amount of space can be provided between the individual concentrators so that the concentrators can operate without shading each other through a larger portion of the day and/or of the year. This innovation would allow the panel to lie flat on the roof rather than having to articulate the entire panel to point at the sun and/or would allow a more cost-effective use of the individual concentrators by increasing their overall daily exposure to sunlight.

Another advantage includes the ability to allow light to be diverted by only one optical element prior to striking a receiver.

Yet another advantage is that a system according to the present invention can be mounted in its target installation (e.g., on residential or commercial rooftops, covered parking structures and walkways, and the like (e.g., to a support post driven deep into the ground)) using whatever technique the installer traditionally uses, whether a non-penetrating flat rooftop mount like the Powerlight® Powerguard® system, an anchored mount for a residential rooftop, a latitude-tilt mount, or even a ground mount or mounting on a single-axis tracker. The installer and end user can choose whatever mounting approach makes the most sense for them.

Additional advantages include one or more of the following: 1) higher efficiencies and/or lower costs (e.g., produce electricity economically and at a cost that can be much lower than many traditional solar panels), 2) the ability to penetrate markets currently dominated by traditional flat solar panels, and/or 3) increased acceleration of deployment of such concentrating solar systems into the market. In preferred embodiments, installers of traditional flat solar panels can use existing mounting hardware and installation techniques to install a concentrating solar system according to the present invention. Even sales and marketing techniques for traditional flat solar panels can be utilized for a concentrating solar panel according to the present invention.

Since many embodiments of the invention will make use of electronics, it is desirable to provide power to operate those electronics, even if the panel has not yet acquired and tracked the sun. The invention accommodates any method for powering the electronics, including but not limited to the following: making use of the power the system generates even when not pointed at the sun; making use of power supplied by an external power supply that is installed as part of the overall solar panel system installation; using a traditional solar panel to provide electronics power for a number of the concentrator panels; and/or building traditional solar cells or miniature panels into the concentrating system itself (for example, on the upper surfaces of the frame) to provide power to operate the electronics (see, e.g., discussion of system 100 in FIG. 10 below).

In preferred embodiments (e.g., as discussed in connection with system 1 below) power is generated for electronics by making use of the power the system generates even when not pointed at the sun.

According to one aspect of the present invention, a photovoltaic power system includes a support structure and a plurality of spaced apart, linear photovoltaic concentrator modules. The support structure has an interface that is structured to be compatible with a pre-existing solar panel form factor. The photovoltaic concentrator modules are coupled to the support structure such that a module is moveable with respect to the support structure.

In preferred embodiments, such a photovoltaic power system can be used to generate electric power by using the photovoltaic power system in a manner so as to photovoltaically convert light energy into electrical energy.

According to another aspect of the present invention, a method of providing a photovoltaic power system includes the step of configuring a support structure of a photovoltaic power system to have a form factor that is compatible with a pre-existing, flat solar panel. The photovoltaic power system includes the support structure and a plurality of spaced apart, linear photovoltaic concentrator modules. The modules are coupled to the support structure such that a module is moveable with respect to the support structure.

According to another aspect of the present invention, a photovoltaic concentrator module includes a reflective trough that concentrates light energy onto a receiver having at least one photovoltaic cell. The trough is coupled to the receiver in a manner such that the trough functions simultaneously as a concentrating optical element, a structural element, and a cooling element.

According to another aspect of the present invention, a photovoltaic power system includes a support structure and a plurality of spaced apart, linear, photovoltaic concentrator modules. The modules are coupled to the support structure such that a module is moveable with respect to the support structure. The modules include a refractive optical element and a reflective optical element. The refractive optical element concentrates light onto a common photovoltaic receiver from a first portion of a light receiving aperture of the module. The reflective optical element concentrates light onto the common photovoltaic receiver from a second portion of the light receiving aperture.

As used herein, a solar concentrator is any device, which uses some optical element, such as a lens, reflector, or solar trap, to concentrate sunlight to high intensity, where it performs some useful purpose, such as heating water, creating electricity, or even cooking food. In the present invention, the solar concentrator(s) help to concentrate sunlight onto one or more solar cells. As used herein, a photovoltaic electricity generator uses a particular photovoltaic device, more commonly known as a solar cell, to convert light into electricity. The invention can make use of any sort of photovoltaic device, including but not limited to traditional silicon solar cells, so-called thermal photovoltaic cells, high tech multi-junction cells or quantum dot cells, or even other patented technologies such as combinations of several kinds of solar cells.

As used herein, a photovoltaic concentrator module uses optics to concentrate light to high intensity onto a solar cell, producing approximately a proportionately larger amount of electricity than the cell would produce under normal illumination. The preferred embodiment for the concentrator module in this invention is shown in FIGS. 2A and 2B as concentrator module 4 (discussed below).

### BRIEF DESCRIPTION OF THE DRAWINGS

FIG. 1A is a schematic drawing showing a perspective view of a concentrating solar panel system according to the present invention;

FIG. 1B is a schematic drawing showing a different perspective view of the system shown in FIG. 1A;

FIG. 2A is a schematic drawing showing a perspective view of a concentrator module from the system shown in FIG. 1A;

FIG. 2B is a schematic drawing showing a perspective view of the trough from the concentrator module shown in FIG. 2A with the end caps and cover removed;

FIG. 3 is a schematic drawing showing a perspective view of the receiver from the trough shown in FIG. 2B;

FIG. 4 is a schematic drawing showing an end view of the system illustrated in FIGS. 1A and 1B to reveal the electronic control unit;

FIG. 5 is a schematic drawing showing a perspective view of the system in FIGS. 1A and 1B and illustrating an exemplary wiring layout;

FIG. 6A is a schematic drawing showing a partial perspective end view of the concentrator module shown in FIG. 2A;

FIG. 6B is a schematic drawing showing the concentrator module illustrated in FIG. 6B in the context of incoming radiation;

FIG. 7A is a schematic flow diagram showing a method of making solar cells for use in the present invention;

FIG. 7B is a schematic flow diagram showing a method of making solar cells for use in the present invention from the solar cells made via the method illustrated in FIG. 7A;

FIG. 8 is a schematic flow diagram showing an alternative method of making solar cells for use in the present invention;

FIG. 9 is a schematic flow diagram showing another alternative method of making solar cells for use in the present invention;

FIG. 10 is a schematic drawing showing a perspective view of an alternative concentrating solar panel system according to the present invention;

FIG. 11 is a schematic drawing showing a perspective view of an alternative concentrator module according to the present invention;

FIG. 12 is a schematic drawing showing a perspective view of another alternative concentrating solar panel system according to the present invention; and

FIG. 13 is a schematic drawing showing a perspective view of another alternative concentrating solar panel system according to the present invention.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

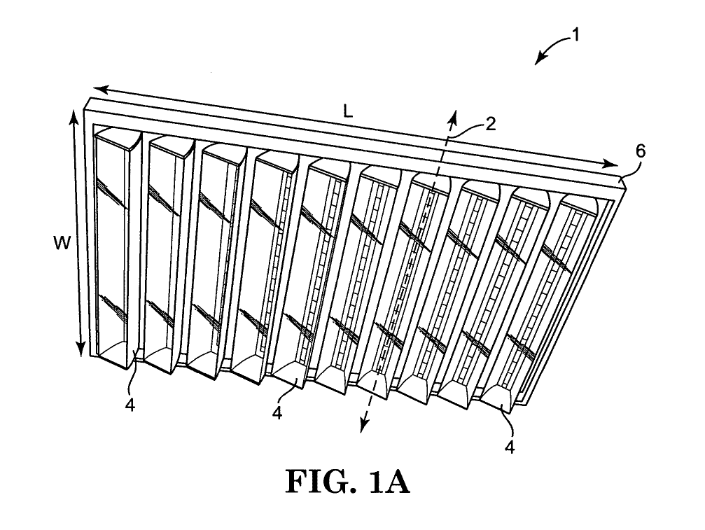

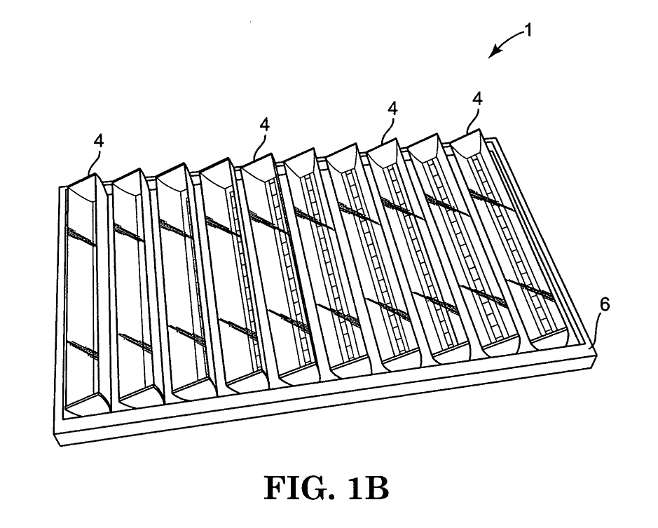

FIGS. 1A-6B illustrate at least part of a preferred photovoltaic power system 1 according to the present invention. Photovoltaic power system 1 includes a plurality of moveable, linear concentrator modules 4 mounted in a frame 6, electronic control unit 22, circuit 28, and mechanical linkages (not shown) that allow movement of the modules 4 to track the sun. As shown, each concentrator module 4 preferably includes a reflective trough 8, a cover 10 incorporating a lens 14 as a portion of the cover 10, a receiver 12, end caps 20, and sensor 24. The modules 4 incorporate a hybrid optical system in which a incident light captured by a first portion of the module aperture is concentrated and reflected onto receiver 12 by reflective trough 8and additional incident light captured by a second portion of the module aperture is concentrated and refracted onto receiver 12 by the lens 14. The portion of the module aperture outside of the lens 14 also allows the modules to capture diffuse light for self power.

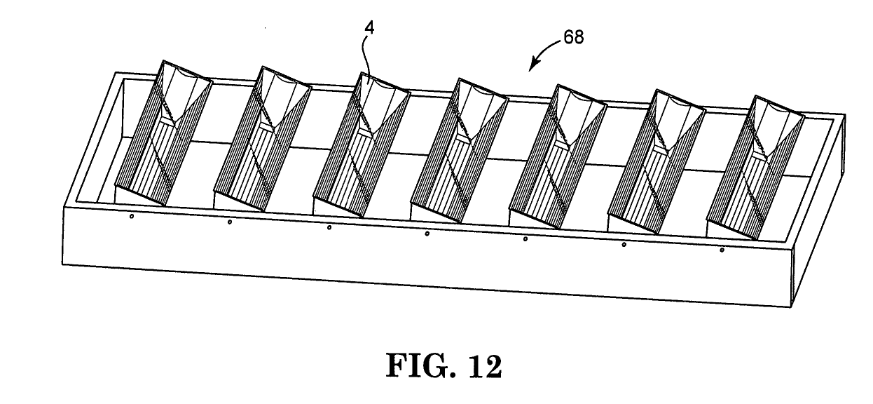

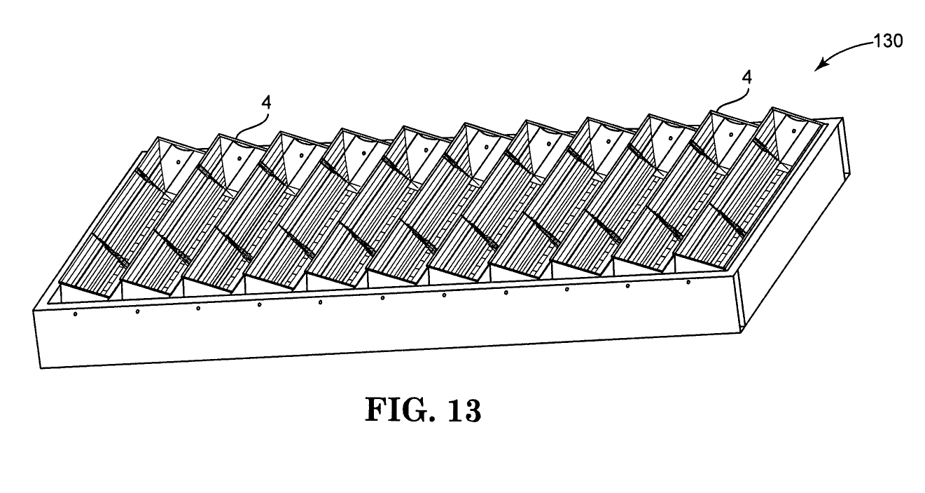

Concentrator modules 4 also include end caps 20 on each trough 8, which preferably connect to one or more drive mechanisms (not shown) and one or more motors (not shown) for positioning and moving the modules 4 to track the sun. System 1 preferably aggregates a multiplicity of concentrator modules 4 into frame 6. The system 1, for purposes of illustration, includes ten individually articulating photovoltaic concentrator modules 4. As alternatives, a lesser or greater number of concentrator modules 4 than as shown in system 1 may be used, if desired, as shown in the embodiments in FIGS. 12 and 13, respectively, described below. Concentrator modules 4 are arrayed uniformly within the frame 6, but they can be positioned in any layout that is suitable.

Note that the individual concentrator modules 4 are preferably spaced slightly apart rather than being closely abutting. This spacing facilitates coupled movement of the individual concentrators 4 without colliding when, for instance, tracking the sun, and it also facilitates a more cost-efficient solar panel, since such a panel may then operate through a larger part of the day and year without the individual concentrator modules 4 substantially shading one another. In representative modes of practice, the modules 4 in system 1 may generate in excess of 130 watts peak of electricity.

The troughs 8 of the individual concentrator modules 4 have an approximately wedge-shaped profile in cross-section, with an overall rain-gutter shape, but any cross-section may be used that is suitable for reflective concentration including but not limited to cylindrical, parabolic, diamond-shaped, hexagonal, square, round, or elliptical. In a specific embodiment, each concentrator module 4 is about 5 inches wide as indicated by the “W” dimension and 5 inches in height as indicated by the “H” dimension. Larger or smaller concentrator modules may be used as well. Additionally, the troughs 8 are shaped as a series of flat facets 9, each at a specific angle relative to the receiver 12 as described in Assignee's U.S. Provisional Patent Application No. 60/759,909, filed Jan. 17, 2006, in the names of Johnson et al., titled A HYBRID PRIMARY OPTICAL COMPONENT FOR OPTICAL CONCENTRATORS, which application is incorporated herein by reference in its entirety for all purposes. Alternative shapes may also be faceted or may have continuous profiles.

In a preferred embodiment, the concentrator modules 4 are vented via small holes or slits (not shown) such as in the end caps 20 or trough 8, helping to prevent pressure buildup and condensation inside of the modules. Alternative embodiments, however, might choose to fully seal the module without providing venting capabilities.

In a preferred embodiment, the reflective trough 8 can perform at least four functions: optical reflection, optical concentration, cooling, and structural support. With respect to reflection and concentration, the trough 8 captures incident light that passes through clear windows 19 of cover 10, and then concentrates and reflects the light onto receiver 12. Solar cells 16 absorb the light and convert it to electricity. With respect to cooling, trough 8 is thermally coupled to the receiver 12 in a manner effective to help passively dissipate heat generated at the receiver 12 due to light concentration there. The trough 8 also serves as part of the structural support and housing for receiver 12 and its components.

In this preferred embodiment, the trough 8 is advantageously made from materials that help the trough 8 serve multiple functions. In this regard, metal materials with highly reflective surfaces have recently become commercially available. The present inventors have appreciated that these materials could be used to fabricate troughs for solar concentrators. The metal material simultaneously supports reflection, concentrating, structural, and cooling functions. As one example, the trough 8 preferably is constructed from high-reflectivity, aluminum sheet metal manufactured by the Alanod Company under the trade designation MIRO (distributed by Andrew Sabel, Inc., Ketchum, Id.).

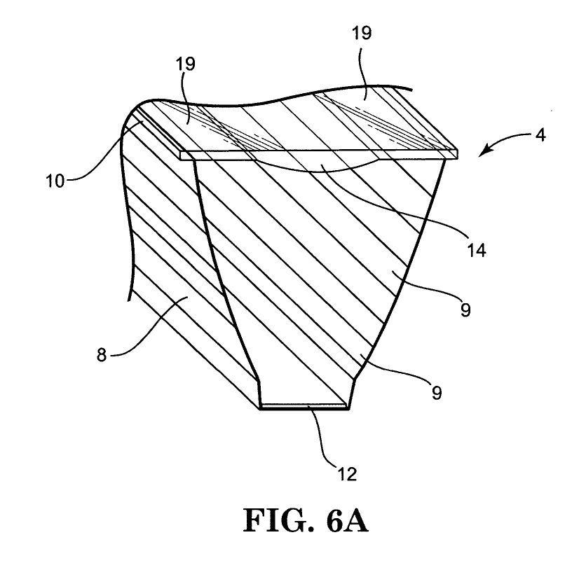

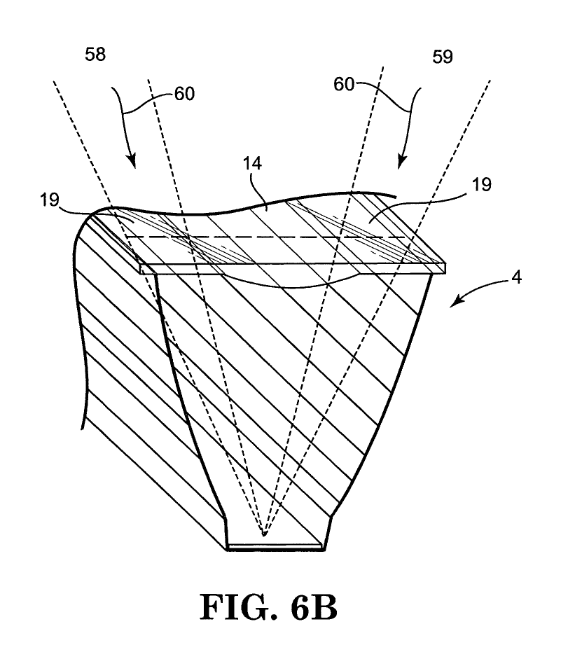

The cover 10 of concentrator module 4 also serves multiple functions such as structural and optical functions and is fitted to trough 8 at the light receiving end of the trough 8. The cover 10 thus corresponds to the primary aperture of module 4 for purposes of capturing incident light. With respect to optical capabilities, a portion of the cover 10 preferably includes a lens 14. Desirably, lens 14 is molded into the underside of the cover 10 such that the cover 10 and lens 14 preferably are formed from a single, unitary part. Light that is incident upon the module aperture served by lens 14 is refracted and concentrated onto receiver 12. Cover 10 also includes a pair of clear windows 19 on either side of the lens 14. These windows 19 serve remaining portions of the module aperture. Incident light captured by these remaining aperture portions can be reflected and concentrated onto receiver 12 by the trough 8. These remaining portions also provide pathways through which diffuse solar radiation can enter the module 4 and strike the receiver 12 to provide self-powering capabilities when module 4 is not tracking the sun. For instance, as can be seen in FIG. 6B, clear windows 19 of this preferred hybrid reflective/refractive system allow additional diffuse radiation 60 to enter from other regions 58 and 59 of the sky, resulting in the collection of several times more diffuse radiation than would be collected if the full aperture were to be served solely by a lens.

Additional advantages and additional features of the hybrid optical system provided collectively by trough 8 and lens 14 are also described in Assignee's U.S. Provisional Patent Application No. 60/759,909, filed Jan. 17, 2006, in the names of Johnson et al., titled A HYBRID PRIMARY OPTICAL COMPONENT FOR OPTICAL CONCENTRATORS, which application is incorporated herein by reference in its entirety for all purposes. For instance, as one additional advantage, the use of this preferred, hybrid optical system enables the height of the optical system to be relatively much more compact for a given optical concentration ratio. The compactness of the height of the optical system allows the concentrator modules 4 to be spaced closely together without colliding as they articulate so as to point from horizon to horizon. Such close spacing is preferred to help produce a cost-effective module 4.

Cover 10 also can preferably provide additional structural support for concentrator module 4 as trough 8 is made much stronger when fitted with a structural member such as, e.g., flat cover 10. The aggregate structural strength of the trough 8/cover 10 combination can be much greater than either component alone, thus helping the unit to pass stringent snow load and other tests required for certification by safety agencies such as Underwriters Laboratories.

Cover 10 preferably also provides a mechanical reference for the width of the mouth of the trough 8. The troughs 8, being preferably manufactured by an inexpensive metal-forming operation, will tend to have variations in the width of their mouths and the angles of their sides due to lot-to-lot variations in one or more of material thickness, stiffness, and the like. The cover 10 preferably has registration features which mate to the mouth of the trough 8, thus helping trough 8 maintain a proper width, and/or maintain a proper shape (e.g., by gently bending, if necessary, at least a portion of the length of the trough 8), preferably within specified tolerances.

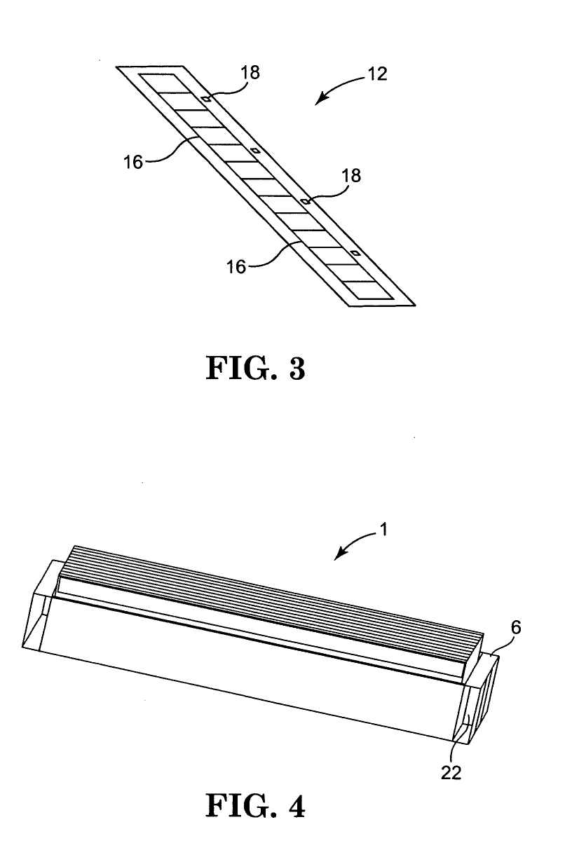

As shown in FIG. 3, receiver 12 preferably includes a plurality of solar cells 16, preferably placed end-to-end along the bottom of each trough 8 and preferably includes one or more bypass diodes 18. Solar cells 16 can be wired electrically either in series or parallel with each other. Optionally, receiver 12 can be wired with other receivers such as in series to produce a high voltage for the entire system 1 that approaches the limits allowed by applicable electrical codes.

Unlike many traditional solar panels, which must be wired in series with a number of other panels in order to achieve such a desirable high voltage when installed, a system according to the present invention advantageously does not need to be wired in series with other systems to produce desired output voltages. For example, system 1 can produce a voltage in the range of 400-600 volts without being coupled to additional systems. Accordingly, a system of the present invention can possibly simplify installation and reduce electrical losses in the on-site wiring.

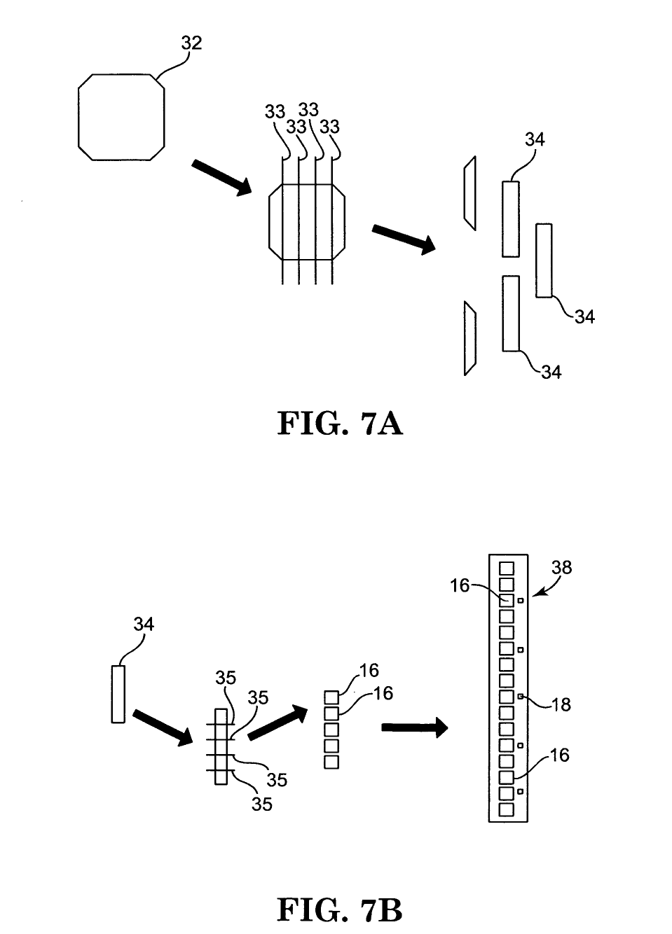

In preferred embodiments, cells 16 are high-efficiency silicon cells or the like, e.g., high efficiency solar cells commercially available from Sunpower Corp. or Q-cells AG. Such preferred cells 16 can be used in receivers 12 in order to achieve a power output which may exceed 130 watts peak, which is commensurate with the output of some flat photovoltaic panels of similar size on the market today. However, alternative embodiments may use any cells that are suitable, including other high-efficiency and/or low-cost cells. Solar cells 16 are preferably narrower in width than standard solar cells. Exemplary methods for making solar cells such as cells 16 are described below in connection with FIGS. 7-9.

Receiver 12 will tend to heat due to the sunlight concentrated onto it at the base of the trough 8. Since the solar cells 16 tend to operate less efficiently at high temperature, it is preferable to cool the cells 16 so as to maintain receiver 12 at a desirable functioning temperature. Typically, either passive cooling (for example fins or sheet-metal strips thermally bonded to the solar cell) or active cooling (combining passive cooling with a fan or similar active element) has been used. Preferably, trough 8 is thermally coupled to the receiver 12 to help dissipate the heat and passively cool receiver 12. Advantageously, in embodiments in which trough 8 is formed from a material such as aluminum, sufficient passive cooling is provided by the trough 8 to keep the solar cells 16 within a desirable temperature range.

As mentioned, receiver 12 also includes diodes 18. Bypass diodes 18 are generally desirable to protect the solar cells 16 from harmful voltages. Depending on details of the solar cells used, an embodiment may include one bypass diode 18 per concentrator module 4, or several concentrator modules 4 may share diodes 18, or one bypass diode 18 may be used for the entire unit, or there may be several bypass diodes 18 per receiver 12. The bypass diodes 18 may be part of the system 1 or they may be external to the system 1. The preferred embodiment has one bypass diode 18 per every few cells 16, resulting in there being several bypass diodes 18 included in each receiver 12.

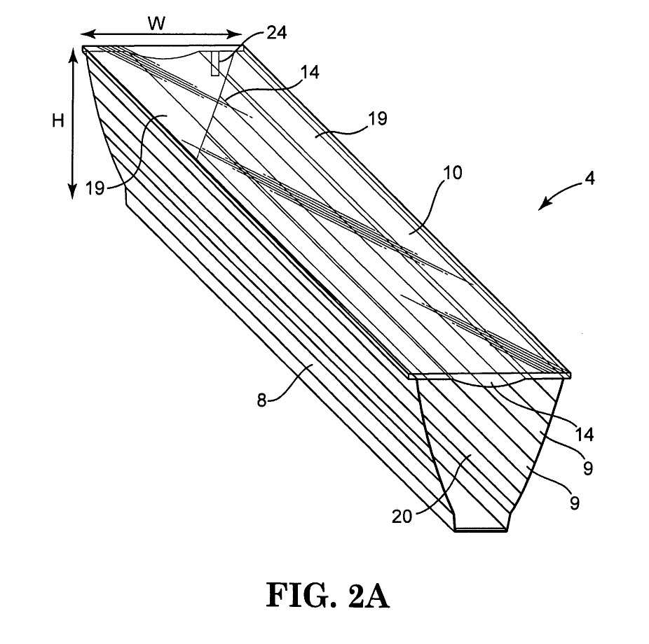

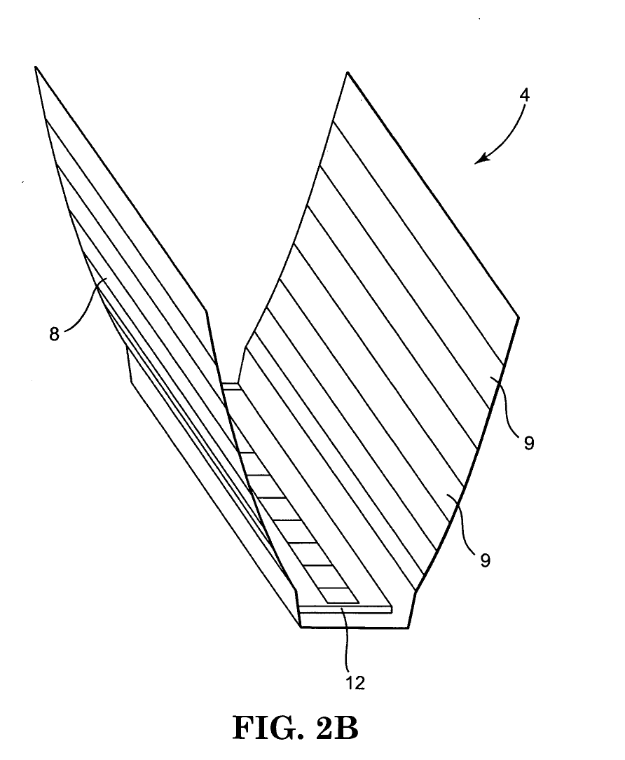

One or more tracking sensor units 24 can be used in connection with system 1. Preferably at least one sensor 24 is used per system 1. As shown in FIG. 2A, concentrator module 4 includes optional tracking sensor unit 24. Preferably sensor unit 24 is present on only some of the concentrator modules 4, for example, on one, two, three, or four of the concentrator modules 4. Sensor 24 informs the electronic control unit 22 of the position of the sun.

System 1 also includes frame 6. Preferably, frame 6 is approximately the size of a traditional solar panel. Traditional solar panels are often 2.5 to 4 feet wide and 4.5 to 6 feet long, and concentrator systems of the present invention advantageously may have this same form factor. However, the size of a solar panel for use in the present invention can be configured to any size desired by the customer or end user within realistic limits. Such limits are generally from as small as 6 inches by 6 inches to as large as 20 feet by 20 feet or even larger, with the upper bound really being dependent on what the customer can easily manipulate and install at a target site. According to one mode of practice, frame 6 is 42 inches wide as indicated by the “W” dimension and is by 67 inches long as indicated by the “L” dimension.

In order for a solar concentrator system 1 of the present invention to produce a desired rated power output, the individual concentrator modules 4 are tilted about their long axis 2 to face the sun. Control of the positioning of modules 4 to track the sun can be accomplished in a number of ways, including passive control (such as refrigerant-based trackers), active control using one electronic control unit per panel, or active control such as by using a single control unit that controls a number of panels. The preferred embodiment of system 1 uses the per-panel active electronics control approach as embodied in the electronic control unit 22 shown in FIG. 4.

For example, according to one control methodology, tracking and moving of the modules 4 may be accomplished by, e.g., having the tracking sensor units 24 sense the position of the sun and provide a pointing error signal to the electronic control unit 22. The electronic control unit 22 then computes the pointing error and provides drive current as needed to one or more motors (not shown), which move one or more drive mechanisms (not shown) to articulate the appropriate concentrator module(s) 4 about their long axes 2 to point at the sun, preferably to an accuracy of better than ±2 degrees. In the preferred embodiment, software within the electronic control unit 22 helps to ensure proper operation during events such as sunrise and sunset, cloud cover, and lack of sufficient power for operation. As shown, electronic control unit 22 of system 1 is preferably mounted inside the frame 6, which articulates the modules 4 via a motor and drive mechanism (not shown).

However, the invention is not specific as to the tracking approach used and will work with any number of tracking approaches, including but not limited to open-loop or model-based pointing, closed-loop pointing based on a local sensor, closed-loop pointing based on optimizing the power output of the panel or of individual concentrator modules or groups of modules, or open- or closed-loop pointing based on a sensor shared by several panels. The software desirably performs open-loop prediction of sun position based on previously received data, and so on.

An alternative is to use electronics alone to provide control, replacing the software with analog or digital electronic components that perform the pointing function. However, a software-based solution is preferred for its versatility and upgradeability.

The electronic control unit 22 requires electrical power to operate. Any suitable power supply may be used. For purposes of illustration, this power is supplied in the illustrated embodiment in the form of self power generated by concentrator modules 4. Advantageously, the hybrid reflective/refractive optical system incorporated into system 1, and as shown in FIGS. 6A and 6B, can capture sufficient diffuse light to produce self power sufficient to control unit 22 and/or any associated equipment (motor(s), drive mechanism(s), and the like) even when the modules 4 are not pointed at the sun. When the modules 4 are not pointed at the sun, diffuse solar radiation entering through one or more windows 19 is captured to self power the electrical control unit 22 and thus any and all associated module-articulation equipment (e.g., drive the motor(s) and drive mechanisms) so that one or more module(s) 4 can then be moved to be pointed at the sun. In the preferred embodiment of system 1, and as shown in FIGS. 6A and 6B, this captured, diffuse radiation is converted by the receiver 12 into a quantity of electricity that may be at least 7.5 times greater than would otherwise be available if the primary aperture of the system 1 were to be served solely by a full aperture lens.

The outputs of the individual concentrator modules 4 may be wired in any desired fashion, such as in series or in parallel, or in some series-parallel combination. The approach to wiring and electrically connecting the various components will be well known to those having skill in the photovoltaic solar concentration field. Any of a variety of approaches may be used. Knowing the voltage per module and number of modules per panel, the modules can be wired to provide an appropriate total voltage.

The unit as a whole may have a single power output, or it may have more than one power output. By wiring the individual concentrators in different ways, an embodiment can achieve any of a wide range of output voltages and currents. It can be configured to approximately match the output voltage of a traditional flat panel, or it can be configured to output higher (or even lower) voltage, with the concomitant change in output current, in order to achieve other benefits at the system level, such as reduced losses in the system wiring.

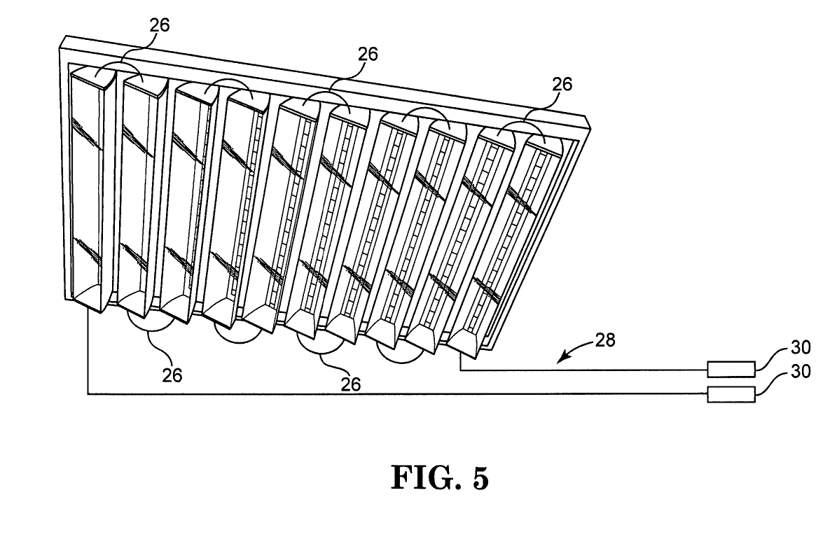

The power circuit 28 of the preferred embodiment is preferably a series connection, as shown schematically in FIG. 5, preferably including the wiring 26 and the power output leads 30. Wiring 26 links the concentrator modules 4 together into a circuit 28. The power output leads 30 deliver the generated power from the concentrator modules 4. Power circuit 28 produces an output voltage of approximately 48 volts, which voltage is supplied at the power output leads 30.

The preferred embodiment includes a simple mechanical linkage (not shown) which articulates the concentrator modules 4 about axis 2 to track the sun, but the invention is not specific as to the type of mechanisms used. Any drivetrain, linkage, and mechanism combination can be used, including but not limited to direct drive, gears, lead screws, cable drive, universal joints, gimbals, flexures, and the like. Similarly, any number of actuation methods can be used, including but not limited to motors, solenoids, nitinol wires, and the like.

There can be individual actuators for each concentrator module 4 (for example, one motor for each concentrator module 4), or the panel can make use of a linkage, cable drive, or other mechanism to allow a single actuator set to move two or more of, or even all of, the concentrator modules 4 together. Similarly, the technique for pivoting is not constrained, with bearings, bushings, flexures, or other approaches as all are supported by the invention. The preferred embodiment in FIGS. 1A-6B envisions a single motor driving a linkage which moves all the concentrator modules 4 in concert.

In the preferred embodiment, the concentrator modules are coupled together with a linkage so that they all move in synchrony, yet each module moves individually about its own axis. Desirably, this movement occurs while the supporting structure is still fixed so that the overall system remains planar. However, alternative embodiments can cause the concentrator modules to move together in small groups. Each group of modules moves about an axis that is common to each group of modules. In such an embodiment, while the outer frame 6 of the unit is still fixed, and the overall system is still planar, the individual modules in each group move about an axis common to the modules in each group and in relation to a neighboring group of modules that move about an axis common to the modules in the neighboring group. Neighboring groups of modules may share the same common axis or may have different common axes. However, the module groups still would be coupled together so that they move in synchrony even though each group moves individually about its own common axis.

The invention also accommodates the inclusion of a further protective transparent cover panel (not shown), made of a material such as glass, polycarbonate, or acrylic, over the entire unit 1.

In use, a set of units 1 may be aggregated together, for example, for the purpose of providing electricity to a home or business. It is noted that the principles of the present invention are not limited to photovoltaic power generation. The concentrated sunlight produced can be used for any purpose, including but not limited to heating of water, solar thermal electric generation, sterilization of water or other materials, and so on.

Several variations to aspects of system 1 are described below.

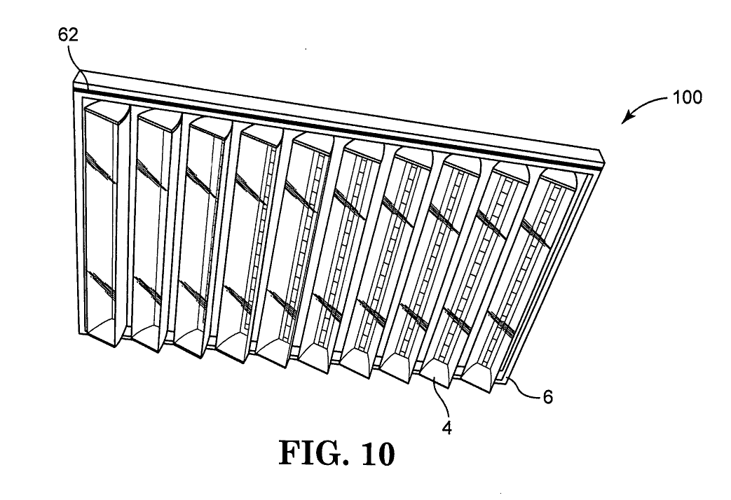

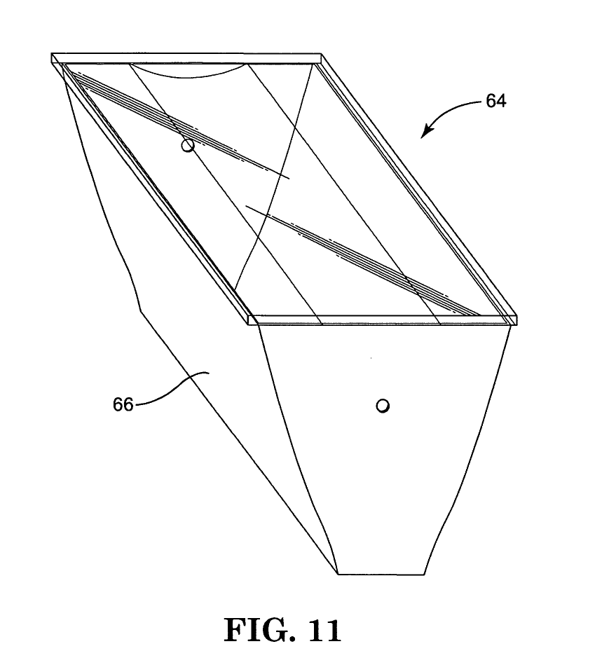

In alternative embodiments, the entire aperture portion of cover 10 may include a lens. A consequence of using such a cover may be that sufficient diffuse light may not enter module 4so as to produce power when the module 4 is not pointed at the sun. In such a case, additional solar cells such as cells 62 may be included in system 1 to help self-power system 1 (cells 62 are discussed below with respect to FIG. 10).

As shown in FIG. 10 and as described in Assignee's co-pending U.S. Provisional Patent Application No. 60/723,589, filed Oct. 4, 2005, in the name of Irwin, titled SELF-POWERED SYSTEMS AND METHODS USING AUXILIARY SOLAR CELLS, which application is incorporated herein by reference in its entirety for all purposes, in such a case system 100 can include an additional set of solar cells 62 on the frame 6 or some other part of system 100. Cells 62 need not be under concentration, and thus can typically produce appreciable electricity from diffuse radiation without regard to how the modules 4 are pointed.

Also, the invention described as an alternative can make use of any sort of concentrating refractive and reflective optical elements, including but not limited to traditional lenses, Fresnel lenses, parabolic, hyperboloidal, or other reflectors, and even other technologies such as a reflective slat concentrator, compound parabolic concentrator, or various solar traps. A number of these alternative optical systems are described in Assignee's U.S. Provisional Patent Application No. 60/759,909, filed Jan. 17, 2006, in the names of Johnson et al., titled A HYBRID PRIMARY OPTICAL COMPONENT FOR OPTICAL CONCENTRATORS. By way of example, the lens 14 that is molded into the cover 10 in the preferred embodiment of system 1 could be in the form of a standard lens or a Fresnel lens. Note that in such a case, the Fresnel lens would not fill the entire entrance aperture of the optical system. That is, the cover 10 would still have windows 19 on each side of the Fresnel lens. Also by way of example, the lens 14 could possibly be molded into the top side of the cover 10 instead of the bottom side as shown in system 1.

A further alternative is to leave out the lens 14 entirely, just having a flat clear cover. While resulting in less power output during normal on-sun operation, this alternative would allow more diffuse radiation to enter, providing yet more power when not pointed at the sun, further easing self-powered operation.

In addition, as an alternative to cover 10, the invention described can make use of any sort of cover, including a domed cover, a cover that is lower or higher than the mouth of the trough 8, or even no cover (in which case some mechanical structure may be desirably utilized to support the lens 14 at its proper location).

FIG. 11 illustrates an alternative concentrator module 64 including a trough 66 which is a smooth hyperboloid and has no facets such as facets 9 in concentrator module 4.

As another alternative, a lesser or greater number of concentrator modules 4 than as shown in system 1 may be used, if desired, as shown in the embodiments in FIGS. 12 and 13, respectively. As shown in FIG. 12, the space between the individual concentrator modules 4 in system 68 can be increased, rather than packing them relatively closer together as shown in system 1. When the modules 4 are spaced further apart, a unit of a given size produces less power, but each individual concentrator module 4 can be more cost-effective, since it can operate through a larger portion of the day and/or year without being shaded by its neighboring concentrator modules 4. This makes more effective use of the receivers 12 and concentrator modules 4, but makes less effective use of the frame 6, motors, linkage, electronic control unit 22, and so on. The space between the modules 4 depends on factors such as the expected annual solar radiation, expected electric utility rates, relative cost of the frame, linkage, receivers, and modules, and so on.

As shown in the embodiment in FIG. 13, system 130 includes eleven concentrator modules 4 instead of only ten concentrator modules 4 as shown in system 1.

Alternative embodiments may also have the concentrator modules 4 not being all coplanar. By way of example, the modules 4 may be terraced, with each module 4 being successively higher above the base of the frame 6 than the one next to it. At the expense of an increased wind profile, this advantageously helps create a system whose field of view is biased in some direction, for example towards the south, as would be desirable for northern hemisphere installations.

While the ability to take on the form of a traditional solar panel is a preferable aspect of the preferred embodiment, square or rectangular panels are not the only possible approach to this invention. In one embodiment (not shown), the frame 6 is eliminated and replaced by a pair of mounting rails or other mounting surfaces, which support and locate the ends of the concentrator modules 4 and could also support the drive and control mechanisms. In such an embodiment, installers would first install the mounting rails or surfaces and then would install individual modules 4 in place on the rails. In further variations of the invention, the electronic control unit 22 could be external to these rails and integrated into the installation on-site by the installer, rather than at the factory during manufacture of the modules or mounts.

As mentioned above, FIGS. 7-9 describe three alternative methods for making solar cells similar to or the same as cells 16.

As shown in FIGS. 7A, cells may be produced by cutting a standard solar cell 32 into strips 34 as indicated by cutting lines 33. Strips 34 may then be placed end-to-end to help produce a receiver (not shown) similar to receiver 12. In a preferred embodiment, strips 34 are 0.5 inches wide and 5 inches long.

Preferably, as shown in FIG. 7B, strips 34 are further cut into smaller pieces 16 (e.g., squares or rectangles) as indicated by cutting lines 35, and these small pieces 16 may be placed side-by-side to help produce a receiver 38 which includes these small pieces 16. In a preferred embodiment, the pieces 16 are 0.5 inches wide and 0.5 inches long.

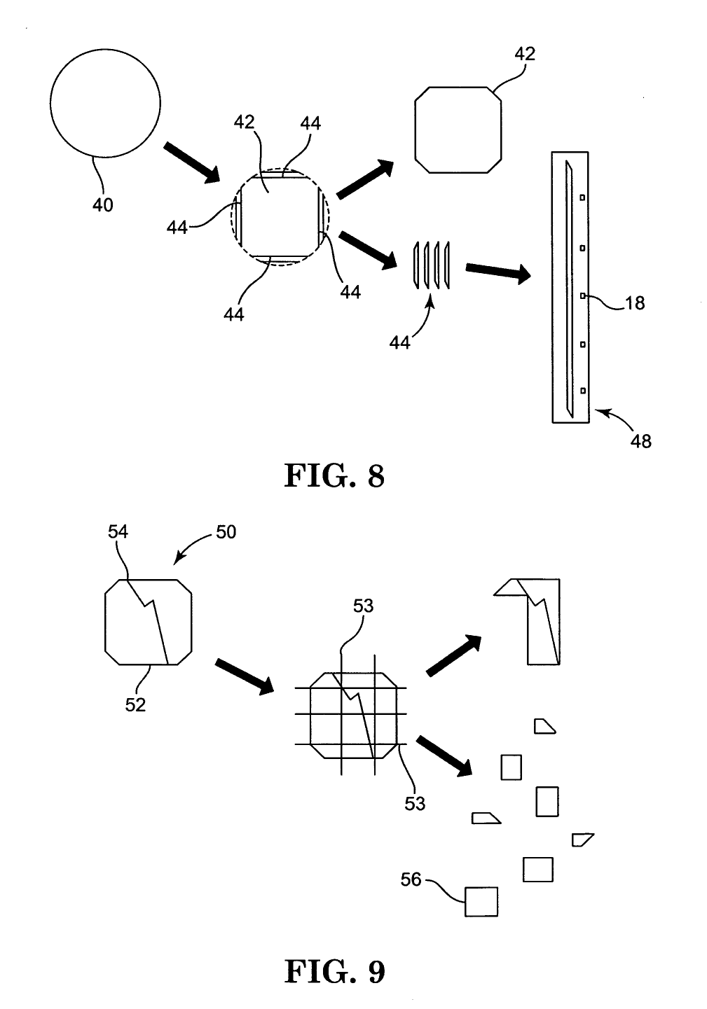

Another desirable method of making cells for a receiver similar to receiver 12 is shown in FIG. 8. FIG. 8 shows that receiver 48 may be constructed by using pieces 44 that would otherwise be discarded as scrap by solar cell manufacturers. Many solar cell fabrication processes start with a round wafer 40, which is trimmed to produce a quasi-square solar cell 42, resulting in a set of scrap pieces 44 that are typically discarded or recycled for further processing. Instead, the receiver 48 could be desirably constructed by including these scrap pieces 44 in the receiver 48. For example, the pieces 44 could be purchased at discount from a solar cell manufacturer.

A related alternative to the method shown in FIG. 8 is shown in FIG. 9. FIG. 9 shows that cells 56 can be constructed using damaged and/or rejected whole cells 50 that would otherwise be discarded as scrap by the manufacturer. Cells 50 may have defects 52 or fractures 54 that prevent them from meeting the manufacturers' specifications. However, small cells 56 may be cut from a defective cell 50 by slicing the cell 50 up as indicated by cutting lines 53 and in such a way as to cut away the defects 52 and fractures 54, leaving useful cells 56 that may then be included in a receiver (not shown).

All cited patents and patent publications are incorporated herein by reference in their respective entireties for all purposes.

What is claimed is:

1. A photovoltaic power system comprising:
(a) a support structure having an interface that is structured to be compatible with a pre-existing solar panel form factor; and
(b) a plurality of spaced apart, linear photovoltaic concentrator modules coupled to the support structure such that a module is moveable with respect to the support structure.

2. The system of claim 1, wherein each module is moveable about a single axis.

3. The system of claim 1, wherein each module is moveable with respect to the support structure.

4. The system of claim 3, wherein the support structure is fixed.

5. The system of claim 1, wherein each module is moveable about a single axis and wherein at least one module is individually moveable with respect to another module.

6. The system of claim 1, wherein the system captures sufficient diffuse incident light and converts such diffuse incident light to electricity such that the system is self-powered.

7. The system of claim 1, further comprising an aperture that captures incident light, wherein a refractive optical element corresponds to a first portion of the aperture and a reflective optical element corresponds to a second portion of the aperture.

8. The system of claim 7, wherein the reflective optical element is a surface of a trough and the refractive optical element is incorporated into a first portion of a cover attached to a light receiving end of the trough such that incident light captured by the first portion is refracted toward a first photovoltaic receiver and light captured by another portion of the cover is reflected onto a second photovoltaic receiver.

9. The system of claim 8, wherein the first and second photovoltaic receivers are the same.

10. The system of claim 1, wherein each module is individually moveable with respect to the other modules.

11. The system of claim 1, wherein the support structure is flat and of similar size and shape to a support structure of a pre-existing solar panel.

12. The system of claim 11, wherein the support structure is selected from the group consisting of a frame or mounting rails.

13. The system of claim 1, wherein the concentrator modules are mechanically coupled into module groups.

14. The system of claim 1, wherein each concentrator module comprises a reflective trough and a refractive lens, said trough and lens having a common optical axis.

15. The system of claim 14, wherein the trough is thermally coupled to a photovoltaic receiver in a manner such that the trough helps to passively dissipate heat from the receiver.

16. The system of claim 1, wherein each concentrator module includes a receiver comprising at least one photovoltaic cell and an optical element that helps to concentrate incident light upon the at least one photovoltaic cell.

17. The system of claim 16, wherein each photovoltaic concentrator module comprises an optical system having a reflective optical element and a refractive optical element, wherein a portion of incident light is concentrated by the reflective optical element onto the at least one photovoltaic cell of the receiver and a separate portion of the incident light is concentrated by the refractive optical element onto at least one photovoltaic cell of the receiver.

18. The system of claim 17, wherein the reflective and refractive optical elements concentrate separate portions of incident light onto a common photovoltaic cell.

19. The system of claim 16, wherein each photovoltaic concentrator module includes an optical system having a non-imaging optical element and an imaging optical element, wherein a portion of incident light is concentrated by the non-imaging optical element onto the at least one photovoltaic cell of the receiver and a separate portion of the incident light is concentrated by the imaging optical element onto the at least one photovoltaic cell of the receiver.

20. The system of claim 1, wherein each photovoltaic concentrator module includes an input aperture having a lens over a portion of the input aperture such that there are other portions of the input aperture through which diffuse light may enter the module without being refracted by the lens.

21. The system of claim 20, wherein the diffuse light entering the module without being refracted by the lens is reflected onto a receiver including at least one photovoltaic cell.

22. The system of claim 1, wherein each photovoltaic concentrator module includes an input aperture that helps to transmit diffuse light onto a photovoltaic receiver of the module.

23. The system of claim 1, wherein the modules are terraced.

24. The system of claim 1, wherein a reflective surface of a trough incorporated into a concentrator module comprises aluminum having a reflective surface.

25. The system of claim 1, wherein a module comprises a reflective trough fitted with a cover, and wherein the module is vented.

26. A method of providing a photovoltaic power system, comprising the step of configuring a support structure of a photovoltaic power system to have a form factor that is compatible with a pre-existing, flat solar panel, wherein the photovoltaic power system comprises:
(a) the support structure; and
(b) a plurality of spaced apart, linear photovoltaic concentrator modules coupled to the support structure such that a module is moveable with respect to the support structure.

27. A method of generating electric power, comprising the step of using the photovoltaic power system of claim 1 in a manner so as to photovoltaically convert light energy into electrical energy.

28. A photovoltaic concentrator module, comprising a reflective trough that concentrates light energy onto a receiver having at least one photovoltaic cell, wherein the trough is coupled to the receiver in a manner such that the trough functions simultaneously as a concentrating optical element, a structural element, and a cooling element.

29. The module of claim 28, further comprising a cover that is coupled to a light receiving end of the trough such that the cover helps to maintain a structural dimension of the trough.

30. The module of claim 29, wherein a portion of the cover includes a refractive optical element that refractively concentrates light onto the receiver.

31. A photovoltaic power system comprising:
(a) a support structure; and
(b) a plurality of spaced apart, linear, photovoltaic concentrator modules coupled to the support structure such that a module is moveable with respect to the support structure, said modules including a refractive optical element that concentrates light onto a common photovoltaic receiver from a first portion of a light receiving aperture of the module and a reflective optical element that concentrates light onto the common photovoltaic receiver from a second portion of the light receiving aperture.
